(19) United States
(12) Patent Application Publication
(10) Pub. No.: US 2018/0368115 A1
(43) Pub. Date: Dec. 20, 2018

(54) DESIGN OF GROUP-COMMON PDCCH

(71) Applicant: Mediatek Inc., Hsin-Chu (TW)

(72) Inventors: Chien-Chang Li, Hsinchu (TW); Chien Hwa Hwang, Hsinchu (TW); Yiju Liao, Hsinchu (TW); Weidong Yang, San Jose, CA (US); Pei-Kai Liao, Hsinchu (TW)

(21) Appl. No.: 16/006,079

(22) Filed: Jun. 12, 2018

Related U.S. Application Data
(60) Provisional application No. 62/520,620, filed on Jun. 16, 2017.

(51) Int. Cl. H04W 72/04

(52) U.S. Cl. CPC H04W 72/042

(57) ABSTRACT

In an aspect of the disclosure, a method, a computer-readable medium, and an apparatus are provided. The apparatus may be a UE. The UE receives resource elements in a time slot. The UE then locates a first control resource set (CORESET) in the resource elements. The UE performs, when the UE is configured to obtain a group common down link control channel, a first blind decoding on the first CORESET to obtain the group common down link control channel based on a group identifier.

### CROSS-REFERENCE TO RELATED APPLICATION(S)

This application claims the benefit of U.S. Provisional Application Ser. No. 62/520,620, entitled “DESIGN OF NR GROUP-COMMON PDCCH” and filed on Jun. 16, 2017, which is expressly incorporated by reference herein in their entirety.

### BACKGROUND

### Field

The present disclosure relates generally to communication systems, and more particularly, to a user equipment (UE) that monitors a group common down link control channel.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE receives resource elements in a time slot. The UE then locates a first control resource set (CORESET) in the resource elements. The UE performs, when the UE is configured to obtain a group common down link control channel, a first blind decoding on the first CORESET to obtain the group common down link control channel based on a group identifier.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a DL frame structure, DL channels within the DL frame structure, an UL frame structure, and UL channels within the UL frame structure, respectively.

FIG. 3 is a diagram illustrating a base station in communication with a UE in an access network.

FIG. 4 illustrates an example logical architecture of a distributed access network.

FIG. 5 illustrates an example physical architecture of a distributed access network.

FIG. 6 is a diagram showing an example of a DL-centric subframe.

FIG. 7 is a diagram showing an example of an UL-centric subframe.

FIG. 8 is a diagram illustrating communications between a base station and UE.

FIG. 9 is a flow chart of a method (process) for processing control information.

FIG. 10 is a flow chart of another method (process) for processing control information.

FIG. 11 is a conceptual data flow diagram illustrating the data flow between different components/means in an exemplary apparatus.

FIG. 12 is a diagram illustrating an example of a hardware implementation for an apparatus employing a processing system-.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

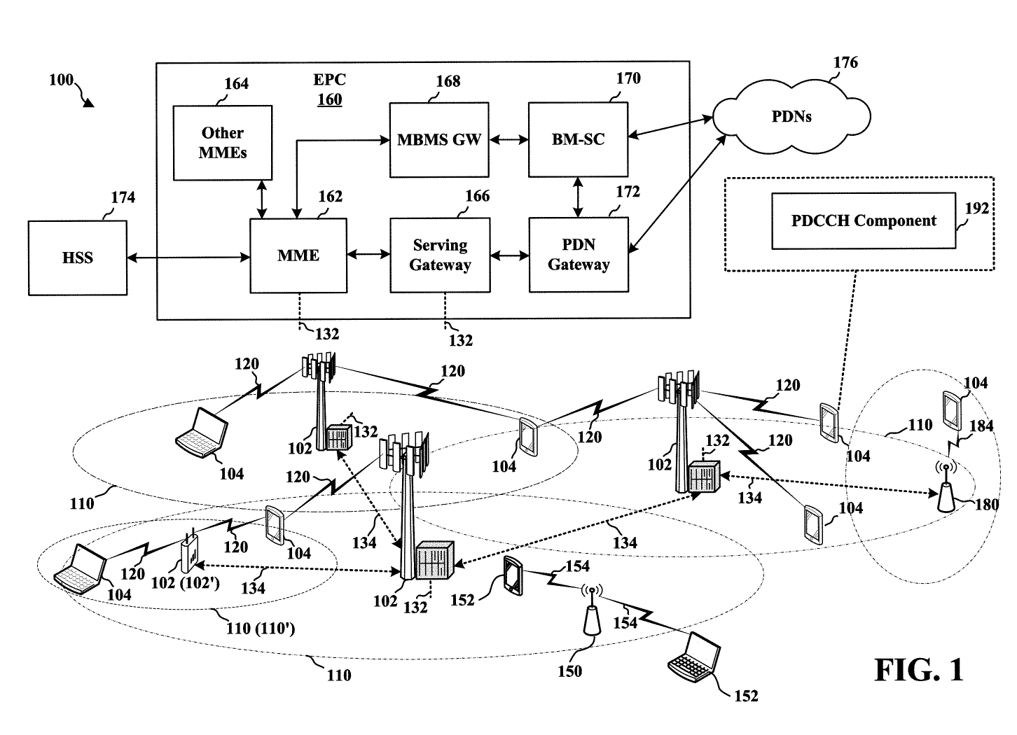

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include base stations. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The gNodeB (gNB) 180 may operate in millimeter wave (mmW) frequencies and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 104 to compensate for the extremely high path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service (PSS), and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a gNB, Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similar functioning device. Some of the UEs 104 may be referred to as IoT devices (e.g., parking meter, gas pump, toaster, vehicles, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In certain aspects, the UE 104 includes, among other components, a PDCCH component 192. The UE receives resource elements in a time slot. The PDCCH component 192 then locates a first control resource set (CORESET) in the resource elements. The PDCCH component 192 performs, when the UE is configured to obtain a group common down link control channel, a blind decoding on the first CORESET to obtain the group common down link control channel based on a group identifier.

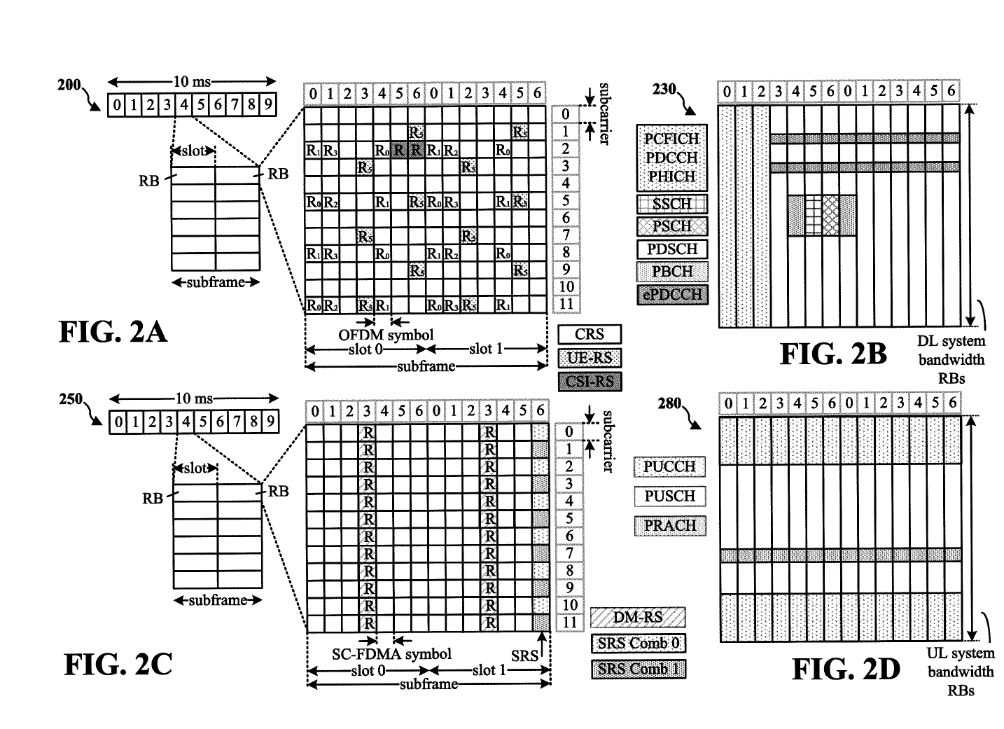

FIG. 2A is a diagram 200 illustrating an example of a DL frame structure. FIG. 2B is a diagram 230 illustrating an example of channels within the DL frame structure. FIG. 2C is a diagram 250 illustrating an example of an UL frame structure. FIG. 2D is a diagram 280 illustrating an example of channels within the UL frame structure. Other wireless communication technologies may have a different frame structure and/or different channels. A frame (10 ms) may be divided into 10 equally sized subframes. Each subframe may include two consecutive time slots. A resource grid may be used to represent the two time slots, each time slot including one or more time concurrent resource blocks (RBs) (also referred to as physical RBs (PRBs)). The resource grid is divided into multiple resource elements (REs). For a normal cyclic prefix, an RB contains 12 consecutive subcarriers in the frequency domain and 7 consecutive symbols (for DL, OFDM symbols; for UL, SC-FDMA symbols) in the time domain, for a total of 84 REs. For an extended cyclic prefix, an RB contains 12 consecutive subcarriers in the frequency domain and 6 consecutive symbols in the time domain, for a total of 72 REs. The number of bits carried by each RE depends on the modulation scheme.

As illustrated in FIG. 2A, some of the REs carry DL reference (pilot) signals (DL-RS) for channel estimation at the UE. The DL-RS may include cell-specific reference signals (CRS) (also sometimes called common RS), UE-specific reference signals (UE-RS), and channel state information reference signals (CSI-RS). FIG. 2A illustrates CRS for antenna ports 0, 1, 2, and 3 (indicated as R0, R1, R2, and R3, respectively), UE-RS for antenna port 5 (indicated as R5), and CSI-RS for antenna port 15 (indicated as R). FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (NACK) feedback based on the physical uplink shared channel (PUSCH). The primary synchronization channel (PSCH) may be within symbol 6 of slot 0 within subframes 0 and 5 of a frame. The PSCH carries a primary synchronization signal (PSS) that is used by a UE to determine subframe/symbol timing and a physical layer identity. The secondary synchronization channel (SSCH) may be within symbol 5 of slot 0 within subframes 0 and 5 of a frame. The SSCH carries a secondary synchronization signal (SSS) that is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DL-RS. The physical broadcast channel (PBCH), which carries a master information block (MIB), may be logically grouped with the PSCH and SSCH to form a synchronization signal (SS) block. The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the base station. The UE may additionally transmit sounding reference signals (SRS) in the last symbol of a subframe. The SRS may have a comb structure, and a UE may transmit SRS on one of the combs. The SRS may be used by a base station for channel quality estimation to enable frequency-dependent scheduling on the UL. FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

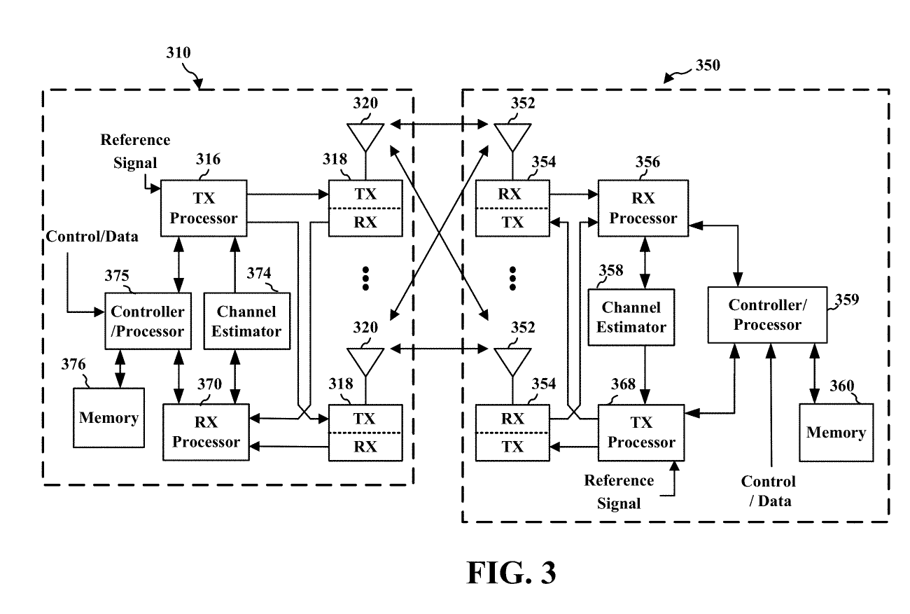

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission. The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

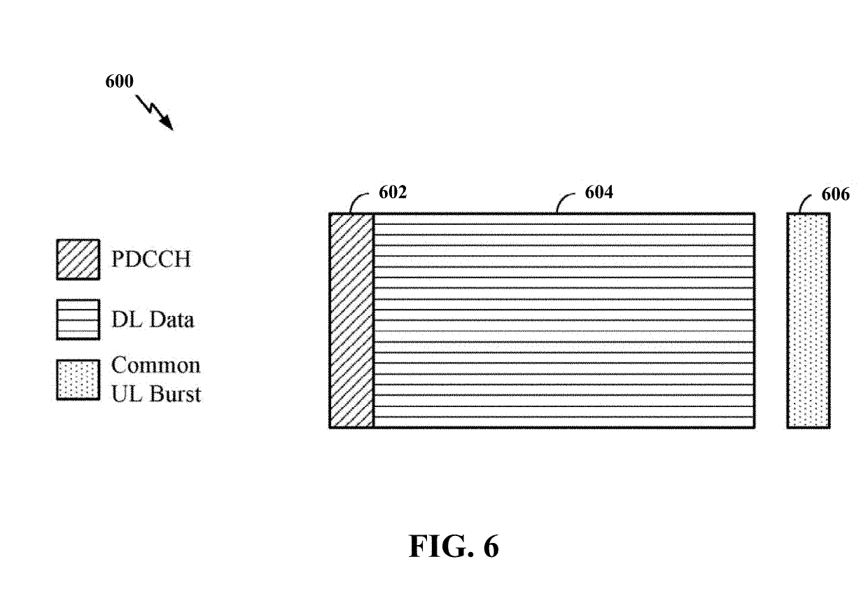

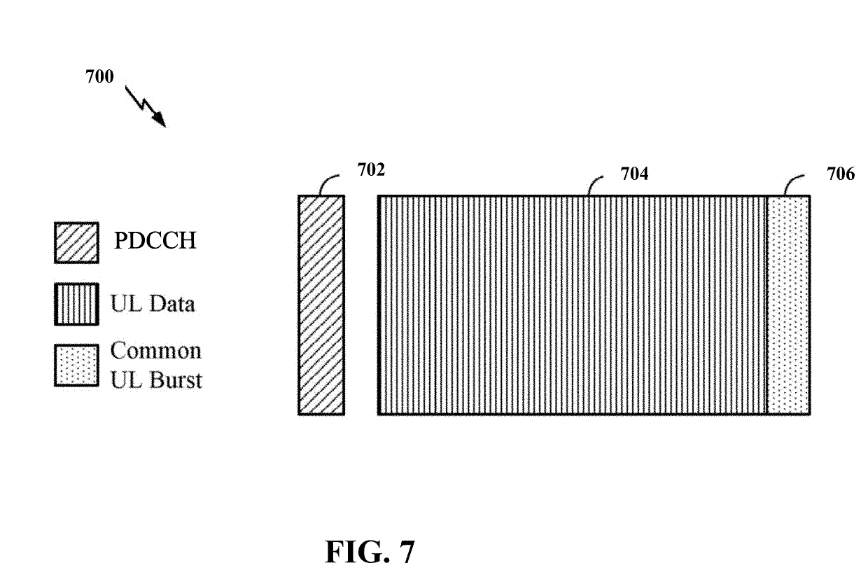

A single component carrier bandwidth of 100 MHZ may be supported. In one example, NR resource blocks (RBs) may span 12 sub-carriers with a sub-carrier bandwidth of 75 kHz over a 0.1 ms duration or a bandwidth of 15 kHz over a 1 ms duration. Each radio frame may consist of 10 or 50 subframes with a length of 10 ms. Each subframe may have a length of 0.2 ms. Each subframe may indicate a link direction (i.e., DL or UL) for data transmission and the link direction for each subframe may be dynamically switched. Each subframe may include DL/UL data as well as DL/UL control data. UL and DL subframes for NR may be as described in more detail below with respect to FIGS. 6 and 7.

Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells. Alternatively, NR may support a different air interface, other than an OFDM-based interface.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

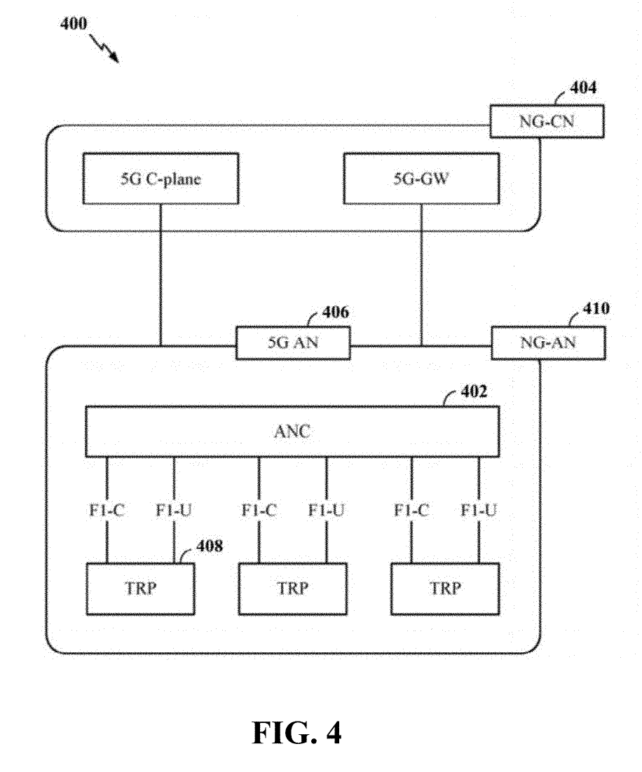

FIG. 4 illustrates an example logical architecture 400 of a distributed RAN, according to aspects of the present disclosure. A 5G access node 406 may include an access node controller (ANC) 402. The ANC may be a central unit (CU) of the distributed RAN 400. The backhaul interface to the next generation core network (NG-CN) 404 may terminate at the ANC. The backhaul interface to neighboring next generation access nodes (NG-ANs) may terminate at the ANC. The ANC may include one or more TRPs 408 (which may also be referred to as BSs, NR BSs, Node Bs, 5G NBs, APs, or some other term). As described above, a TRP may be used interchangeably with “cell.”

The TRPs 408 may be a distributed unit (DU). The TRPs may be connected to one ANC (ANC 402) or more than one ANC (not illustrated). For example, for RAN sharing, radio as a service (RaaS), and service specific AND deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 400 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 410 may support dual connectivity with NR. The NG-AN may share a common fronthaul for LTE and NR.

The architecture may enable cooperation between and among TRPs 408. For example, cooperation may be preset within a TRP and/or across TRPs via the ANC 402. According to aspects, no inter-TRP interface may be needed/present.

According to aspects, a dynamic configuration of split logical functions may be present within the architecture of the distributed RAN 400. The PDCP, RLC, MAC protocol may be adaptably placed at the ANC or TRP.

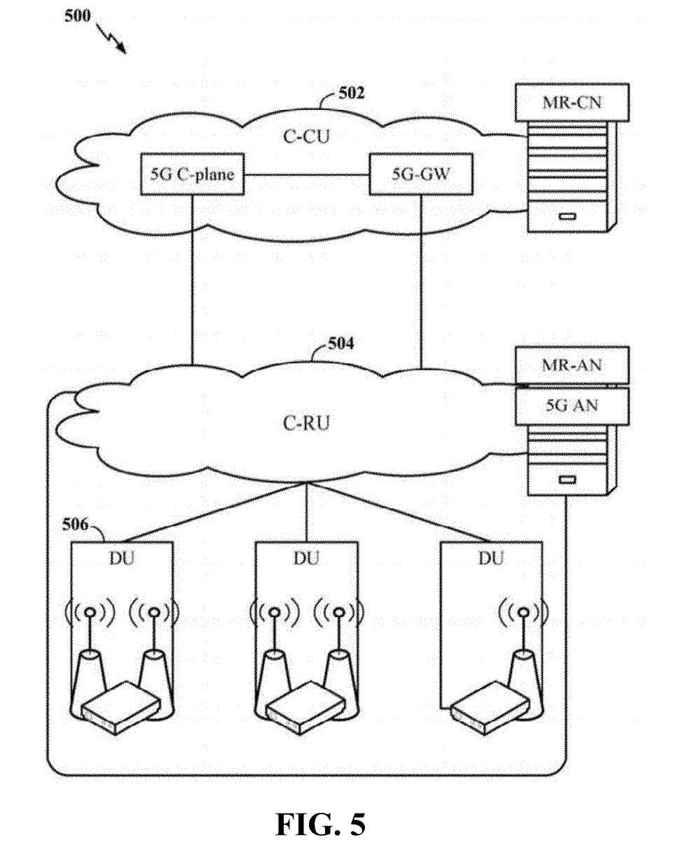

FIG. 5 illustrates an example physical architecture of a distributed RAN 500, according to aspects of the present disclosure. A centralized core network unit (C-CU) 502 may host core network functions. The C-CU may be centrally deployed. C-CU functionality may be offloaded (e.g., to advanced wireless services (AWS)), in an effort to handle peak capacity. A centralized RAN unit (C-RU) 504 may host one or more ANC functions. Optionally, the C-RU may host core network functions locally. The C-RU may have distributed deployment. The C-RU may be closer to the network edge. A distributed unit (DU) 506 may host one or more TRPs. The DU may be located at edges of the network with radio frequency (RF) functionality.

FIG. 6 is a diagram 600 showing an example of a DL-centric subframe. The DL-centric subframe may include a control portion 602. The control portion 602 may exist in the initial or beginning portion of the DL-centric subframe. The control portion 602 may include various scheduling information and/or control information corresponding to various portions of the DL-centric subframe. In some configurations, the control portion 602 may be a physical DL control channel (PDCCH), as indicated in FIG. 6. The DL-centric subframe may also include a DL data portion 604. The DL data portion 604 may sometimes be referred to as the payload of the DL-centric subframe. The DL data portion 604 may include the communication resources utilized to communicate DL data from the scheduling entity (e.g., UE or BS) to the subordinate entity (e.g., UE). In some configurations, the DL data portion 604 may be a physical DL shared channel (PDSCH).

The DL-centric subframe may also include a common UL portion 606. The common UL portion 606 may sometimes be referred to as an UL burst, a common UL burst, and/or various other suitable terms. The common UL portion 606 may include feedback information corresponding to various other portions of the DL-centric subframe. For example, the common UL portion 606 may include feedback information corresponding to the control portion 602. Non-limiting examples of feedback information may include an ACK signal, a NACK signal, a HARQ indicator, and/or various other suitable types of information. The common UL portion 606 may include additional or alternative information, such as information pertaining to random access channel (RACH) procedures, scheduling requests (SRs), and various other suitable types of information.

As illustrated in FIG. 6, the end of the DL data portion 604 may be separated in time from the beginning of the common UL portion 606. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric subframe and alternative structures having similar features may exist without necessarily deviating from the aspects described herein.

FIG. 7 is a diagram 700 showing an example of an UL-centric subframe. The UL-centric subframe may include a control portion 702. The control portion 702 may exist in the initial or beginning portion of the UL-centric subframe. The control portion 702 in FIG. 7 may be similar to the control portion 602 described above with reference to FIG. 6. The UL-centric subframe may also include an UL data portion 704. The UL data portion 704 may sometimes be referred to as the pay load of the UL-centric subframe. The UL portion may refer to the communication resources utilized to communicate UL data from the subordinate entity (e.g., UE) to the scheduling entity (e.g., UE or BS). In some configurations, the control portion 702 may be a physical DL control channel (PDCCH).

As illustrated in FIG. 7, the end of the control portion 702 may be separated in time from the beginning of the UL data portion 704. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric subframe may also include a common UL portion 706. The common UL portion 706 in FIG. 7 may be similar to the common UL portion 706 described above with reference to FIG. 7. The common UL portion 706 may additionally or alternatively include information pertaining to channel quality indicator (CQI), sounding reference signals (SRSs), and various other suitable types of information. One of ordinary skill in the art will understand that the foregoing is merely one example of an UL-centric subframe and alternative structures having similar features may exist without necessarily deviating from the aspects described herein.

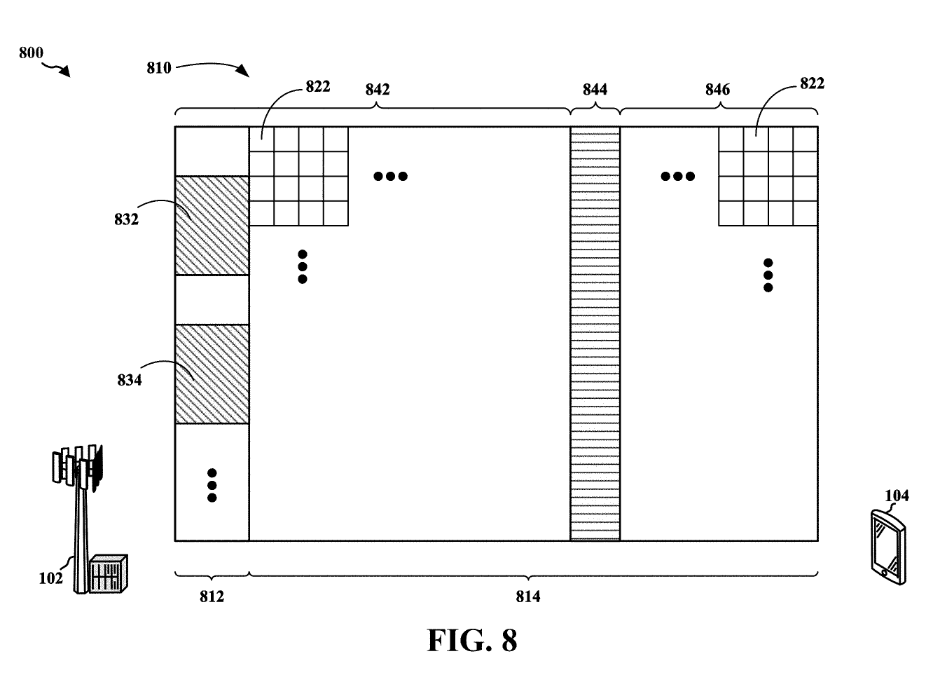

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).
FIG. 8 is a diagram 800 illustrating communications between a base station 102 and a UE 104. The base station 102 communicates with the UE 104 on a carrier in a slot 810. The frequency resources and time resources in the slot 810 forms resource elements 822. Each of the resource elements 822 spans one symbol period by one subcarrier.

The slot 810 includes a control region 812 and a data region 814. Further, in this example, the control region 812 includes a CORESET 832, a CORESET 834, etc. In addition, the CORESET 832 may be a common CORESET and the CORESET 834 may be an additional CORESET. Further, the slot 810 may be divided into 3 portions: a down-link portion 842 at the beginning, an up-link portion 846 at the end, and a gap portion 844 between the down-link portion 842 and the up-link portion 846. The base station 102 transmits down-link signals to the UE 104 in the down-link portion 842. The UE 104 transmits up-link signals to the base station 102 in the up-link portion 846. The UE 104 and the base station 102 do not transmit signals in the gap portion 844.

The base station 102 may transmit a GC PDCCH in a common search space (CSS) of the CORESET 832 or the CORESET 834. The aggregation level of the CCEs in the CSS may 4, 8, or 16. The base station 102 may first use a common CORESET (e.g., the CORESET 832) to transmit the GC PDCCH. If the capacity of the common CORESET is not enough, the base station 102 can configure an additional CORESET for the UE 104 by higher layer RRC signaling.

When the base station 102 transmit a GC PDCCH in the slot 810, especially when the GC PDCCH carries information concerning the slot 810 itself (e.g., duration of CORESET or size of the gap portion 844), the base station 102 uses more limited number of candidate locations for the GC PDCCH than that for other PDCCHs. This technique allows the UE 104 to search first for the GC PDCCH and to make use of the conveyed information sooner. For example, if the UE 104 finds that in the slot 810 only one symbol period is used for control, then the UE 104 can skip blind detection over the second symbol period with potential PDCCH transmissions).

In one example, the base station 102 is configured to place the GC PDCCH at the first candidate CCE positions at a given aggregation level. To further reduce the latency for GC PDCCH decoding, the base station 102 may choose to support a GC PDCCH at higher aggregation levels (8 or above) only. Restricting the aggregation levels and candidate CCE positions used for the GC PDCCH can also benefits a sniffer, either a base station or a UE from another cell, alleviating the effort to extract information from the GC PDCCH. For example, assume that the CSS contains aggregation level (AL) 4 and 8, and both AL=4 and AL=8 are configured with 4 candidates. If the GC is configured with 2 candidates, then the UE will use the first 2 candidates for AL=4 and the first 2 candidates for AL=8.

In certain configurations, the GC PDCCH can have the same size as some other UE specific PDCCHs (e.g., PDCCHs for compact downlink or uplink scheduling, downlink assignment, uplink grant, etc.). To differentiate between the GC PDCCH and other UE specific PDCCHs, the base station 102 may associate a group radio network temporary identifier (RNTI) with the GC PDCCH. In one example, the group RNTI, paging RNTI, system information RNTI can all consist of 16 bits. More specifically, the base station 102 generate a CRC for the DCI bits of the GC PDCCH. The base station 102 then use the group RNTI to scramble the DCI bits and the CRC. The scrambled bits are then send to an encoder.

The group RNTI can be configured for the UE 104. Alternatively, the group RNTIs can be specified in the specification/standards. The UE 104 can derive the group RNTI through a mapping between a group ID and a group RNTI. The group ID can be configured for a UE or it can be derived from the UE ID through a hash function.

In certain circumstances, it may be beneficial to specify the group RNTIs in the specification: in the case a sniffer (e.g. a UE or a base station from another cell) needs to blindly detect a GC PDCCH, the detection effort can be minimized. However, even if the group RNTI taking a value from a whole range that is configured for a UE, inter-gNB communication can be used to provide information about the group RNTIs from one cell to another, thus reducing the detection effort at a sniffer. As described supra, the group RNTI can be used to derive a mask for PDCCH CRC. The blind detection effort may not be much increased if a UE needs to decode the GC PDCCH.

The network, through the base station 102, may send to the UE 104 semi-static assignments containing periodicity, a subset of fixed down-link transmission, and a subset of fixed up-link transmission. Resources that do not belong to fixed down-link transmission or fixed up-link transmission are flexible resources. In certain configurations, the base station 102 can use GC PDCCH assign the direction of transmission (e.g., down-link or up-link) of the flexible resources for one slot or multiple slots. In particular, GC PDCCH may contain slot format information (SFI) that assigns the transmission direction of the flexible resources.

In one example, the UE 104 is not configured to detect and decode GC PDCCH carried in the slot 810. As such, when the UE 104 has received the semi-static assignment of the transmission direction from the higher layer RRC signaling, then UE follows the semi-static assignment. When the UE 104 has not received the semi-static assignment, the UE 104 monitors PDCCH carried in the slot 810, and performs radio resource management measurement, periodic CSI measurement, and reporting according to the PDCCH.

In another example, the UE 104 is configured to detect the GC PDCCH carried in the slot 810, but is not able to detect the GC PDCCH in the slot 810. The UE 104 only knows the fixed down-link resources and the fixed up-link resource according to the semi-static assignment. The UE 104 does not know the transmission direction of the flexible resources. Therefore, the UE 104 monitors PDCCH(s) carried in the slot 810. The UE 104 may perform RRM measurement or periodic CSI measurement/reporting if pre-configured periodic reference signals (CSI-RS, SS block, SRS) and CSI reporting resource is located within the fixed down-link resources/up-link resources.

In certain configurations, the UE 104 is configured to detect the GC PDCCH carried in the slot 810. In this example, the UE 104 is able to detect the GC PDCCH. As described supra, the GC PDCCH may carry SFI. If the direction of a particular time slot as indicated by the SFI is not consistent with a direction indicated by PDCCH(s) of the particular time slot, the UE 104 determines that an error occurred with respect to the particular time slot.

Further, if the direction of a particular time slot indicated by the SFI is not consistent with a direction of the fixed direction resources configured by semi-static signaling (where the particular time slot contained the fixed direction resources), the UE 104 determines that an error occurred with respect to the particular time slot.

Further, based on configurations, the UE 104 may determine that a particular slot includes periodic signals (e.g., CSI-RS, SS block, or SRS). If the direction of a particular time slot indicated by the SFI is not consistent with a direction according to the periodic signals or CSI reporting, the UE 104 follows the direction of SFI.

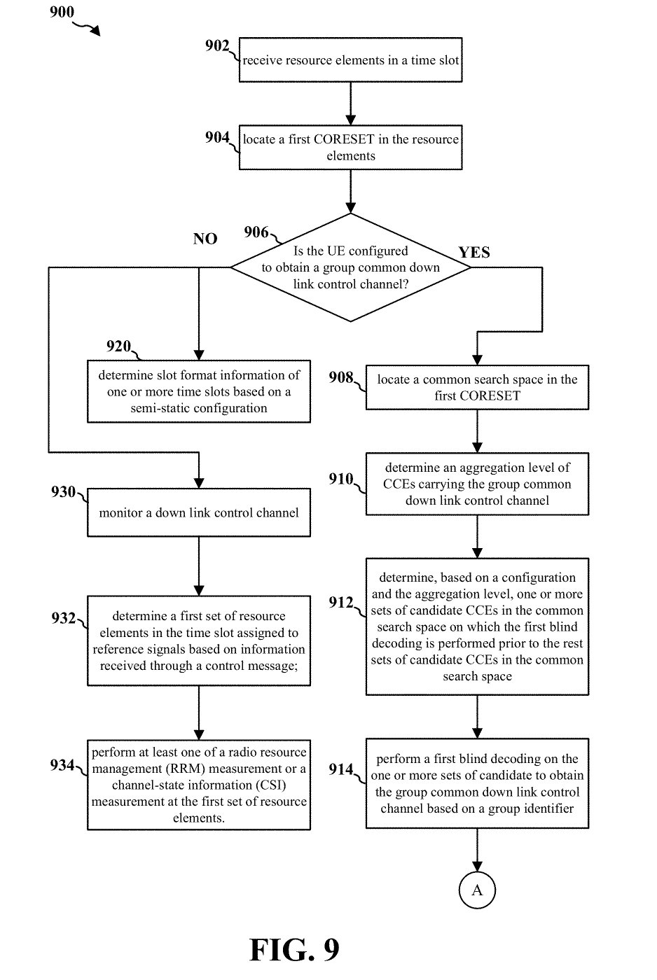

FIG. 9 is a flow chart 900 of a method (process) for processing control information. The method may be performed by a UE (e.g., the UE 104, the apparatus 1102, and the apparatus 1102′).

At operation 902, the UE receives resource elements (e.g., the resource elements 822) in a time slot (e.g., the slot 810). At operation 904, the UE locates a first CORESET (e.g., the CORESET 832 or the CORESET 834) in the resource elements. At operation 906, the UE proceed with different operations in accordance with whether the UE is configured to obtain a group common down link control channel.

When the UE is configured to obtain the group common down link control channel, the UE, at operation 908, locates a common search space in the first CORESET. At operation 910, the UE determines an aggregation level of CCEs carrying the group common down link control channel. At operation 912, the UE determines, based on a configuration and the aggregation level, one or more sets of candidate CCEs in the common search space on which the first blind decoding is performed prior to the rest sets of candidate CCEs in the common search space. The group common down link control channel is carried in one of the one or more sets of candidate CCEs. At operation 914, the UE performs a first blind decoding on the one or more sets of candidate CCEs to obtain the group common down link control channel based on a group identifier. Subsequently, the UE continues to operation 1002.

When the UE is not configured to obtain the group common down link control channel, and when a semi-static configuration is received at the UE, the UE may, at operation 920, determines slot format information of one or more time slots based on a semi-static configuration when the semi-static configuration is received at the UE.

When the UE is not configured to obtain the group common down link control channel, and when a semi-static configuration is not received at the UE, the UE may, at operation 930, monitors a UE specific down link control channel. At operation 932, the UE determines a first set of resource elements in the time slot assigned to reference signals based on information received through a control message. At operation 934, the UE performs at least one of a radio resource management (RRM) measurement or a channel-state information (CSI) measurement at the first set of resource elements when each resource element of the first set of resource elements is in a down-link direction according to the UE specific down link control channel.

In certain configurations, the first CORESET is a common CORESET. The first CORESET is determined based on information carried by a system information transmission. In certain configurations, the system information transmission is a master information block (MIB). In certain configurations, the first CORESET is an additional CORESET. The CORESET is determined based on information carried by a control message. In certain configurations, the control message is a radio resource control (RRC) message.

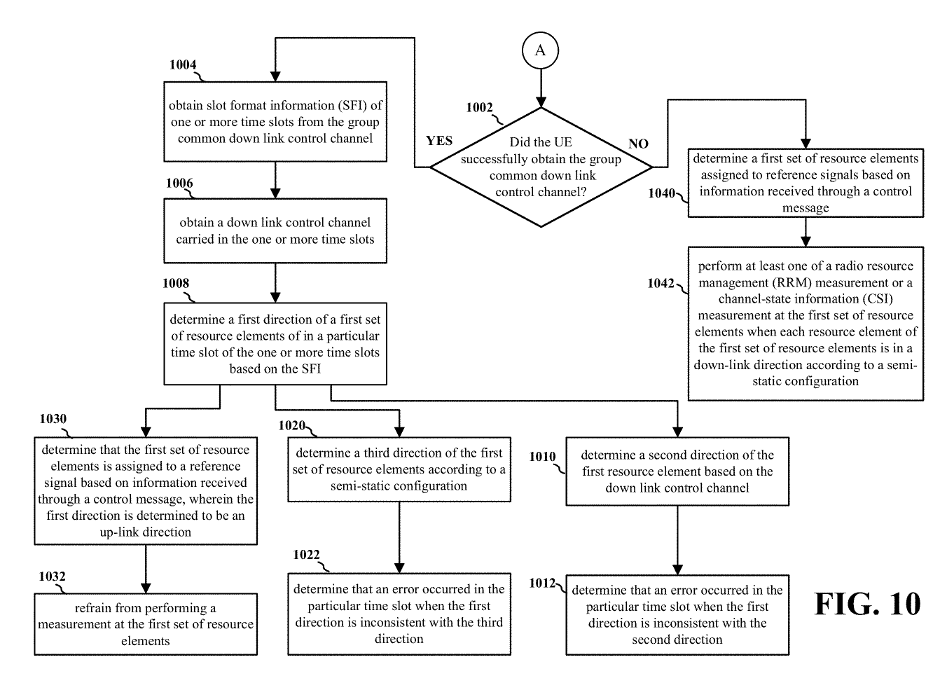

FIG. 10 is a flow chart 1000 of a method (process) for processing control information. The method may be performed by a UE (e.g., the UE 104, the apparatus 1102, and the apparatus 1102′).

At operation 1002, the UE determines whether it successfully obtained the group common down link control channel through the first blind decoding. When the UE successfully obtained the group common down link control channel through the first blind decoding, at operation 1004, the UE obtains slot format information (SFI) of one or more time slots from the group common down link control channel. At operation 1006, the UE obtains a UE specific down link control channel carried in the one or more time slots. At operation 1008, the UE determines a first direction of a first set of resource elements of in a particular time slot of the one or more time slots based on the SFI.

In certain configurations, the UE, at operation 1010, determines a second direction of the first resource element based on the UE specific down link control channel. At operation 1012, the UE determines that an error occurred in the particular time slot when the first direction is inconsistent with the second direction.

In certain configurations, the UE, at operation 1020, determines a third direction of the first set of resource elements according to a semi-static configuration. At operation 1022, the UE determines that an error occurred in the particular time slot when the first direction is inconsistent with the third direction.

In certain configurations, the UE, at operation 1030, determines that the first set of resource elements is assigned to a reference signal based on information received through a control message and that the first direction is an up-link direction. At operation 1032, the UE refrains from performing a measurement at the first set of resource elements.

When the UE failed to obtain the group common down link control channel through the first blind decoding, at operation 1040, the UE determines a first set of resource elements assigned to reference signals based on information received through a control message. At operation 1042, the UE performs at least one of a radio resource management (RRM) measurement or a channel-state information (CSI) measurement at the first set of resource elements when each resource element of the first set of resource elements is in a down-link direction according to a semi-static configuration.

In certain configurations, the group identifier is a group radio-network temporary identifier (RNTI). The UE may perform a second blind decoding on the common search space based on another RNTI, when the UE fails to obtain the group common down link control channel through the first blind decoding.

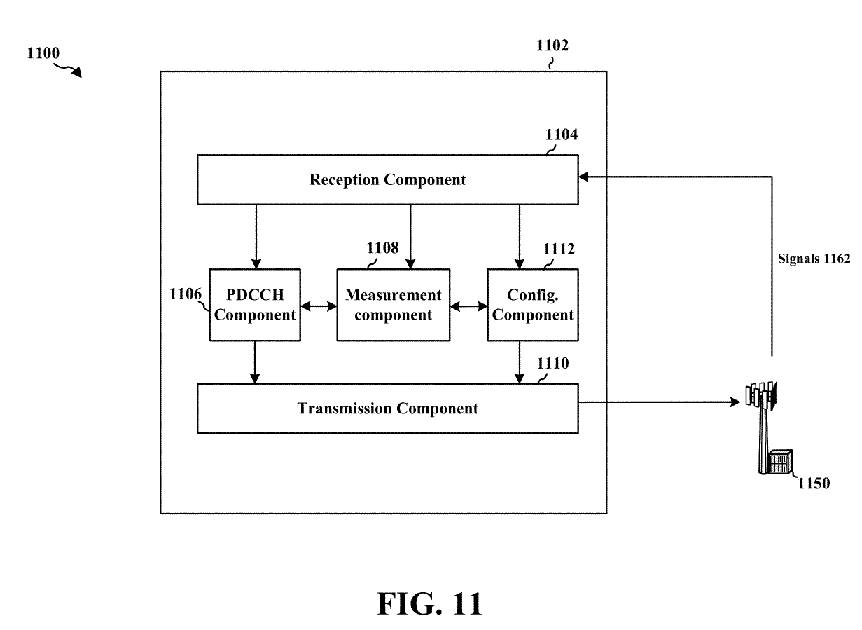

FIG. 11 is a conceptual data flow diagram 1100 illustrating the data flow between different components/means in an exemplary apparatus 1102. The apparatus 1102 may be a base station. The apparatus 1102 includes a reception component 1104, a PDCCH component 1106, a measurement component 1108, a configuration component 1112, and a transmission component 1110.

The reception component 1104 receives, from a base station 1150, resource elements 1162 in a time slot. The PDCCH component 1106 locates a first CORESET in the resource elements 1162. The PDCCH component 1106 proceed with different operations in accordance with whether the PDCCH component 1106 is configured to obtain a group common down link control channel.

When the PDCCH component 1106 is configured to obtain the group common down link control channel, the PDCCH component 1106 locates a common search space in the first CORESET. The PDCCH component 1106 determines an aggregation level of CCEs carrying the group common down link control channel. The PDCCH component 1106 determines, based on a configuration and the aggregation level, one or more sets of candidate CCEs in the common search space on which the first blind decoding is performed prior to the rest sets of candidate CCEs in the common search space. The group common down link control channel is carried in one of the one or more sets of candidate CCEs. The PDCCH component 1106 performs a first blind decoding on the one or more sets of candidate CCEs to obtain the group common down link control channel based on a group identifier.

When the PDCCH component 1106 is not configured to obtain the group common down link control channel, and when a semi-static configuration is received at the configuration component 1112, the configuration component 1112 may determines slot format information of one or more time slots based on a semi-static configuration when the semi-static configuration is received at the UE.

When the PDCCH component 1106 is not configured to obtain the group common down link control channel, and when a semi-static configuration is not received at the configuration component 1112, the PDCCH component 1106 may monitors a UE specific down link control channel. The configuration component 1112 determines a first set of resource elements in the time slot assigned to reference signals based on information received through a control message. The measurement component 1108 performs at least one of a radio resource management (RRM) measurement or a channel-state information (CSI) measurement at the first set of resource elements when each resource element of the first set of resource elements is in a down-link direction according to the UE specific down link control channel.

In certain configurations, the first CORESET is a common CORESET. The first CORESET is determined based on information carried by a system information transmission. In certain configurations, the system information transmission is a master information block (MIB). In certain configurations, the first CORESET is an additional CORESET. Then the first CORESET is determined based on information carried by a control message. In certain configurations, the control message is a radio resource control (RRC) message.

The PDCCH component 1106 determines whether it successfully obtained the group common down link control channel through the first blind decoding. When the PDCCH component 1106 successfully obtained the group common down link control channel through the first blind decoding, the PDCCH component 1106 obtains slot format information (SFI) of one or more time slots from the group common down link control channel. The PDCCH component 1106 obtains a UE specific down link control channel carried in the one or more time slots. The PDCCH component 1106 determines a first direction of a first set of resource elements of in a particular time slot of the one or more time slots based on the SFI.

In certain configurations, the PDCCH component 1106 determines a second direction of the first resource element based on the UE specific down link control channel. The PDCCH component 1106 determines that an error occurred in the particular time slot when the first direction is inconsistent with the second direction.

In certain configurations, the configuration component 1112 determines a third direction of the first set of resource elements according to a semi-static configuration. The configuration component 1112 determines that an error occurred in the particular time slot when the first direction is inconsistent with the third direction.

In certain configurations, the measurement component 1108 determines that the first set of resource elements is assigned to a reference signal based on information received through a control message and that the first direction is an up-link direction. The measurement component 1108 refrains from performing a measurement at the first set of resource elements.

When the PDCCH component 1106 failed to obtain the group common down link control channel through the first blind decoding, the measurement component 1108 determines a first set of resource elements assigned to reference signals based on information received through a control message. The measurement component 1108 performs at least one of a radio resource management (RRM) measurement or a channel-state information (CSI) measurement at the first set of resource elements when each resource element of the first set of resource elements is in a down-link direction according to a semi-static configuration.

In certain configurations, the group identifier is a group radio-network temporary identifier (RNTI). The UE may perform a second blind decoding on the common search space based on another RNTI, when the UE fails to obtain the group common down link control channel through the first blind decoding.

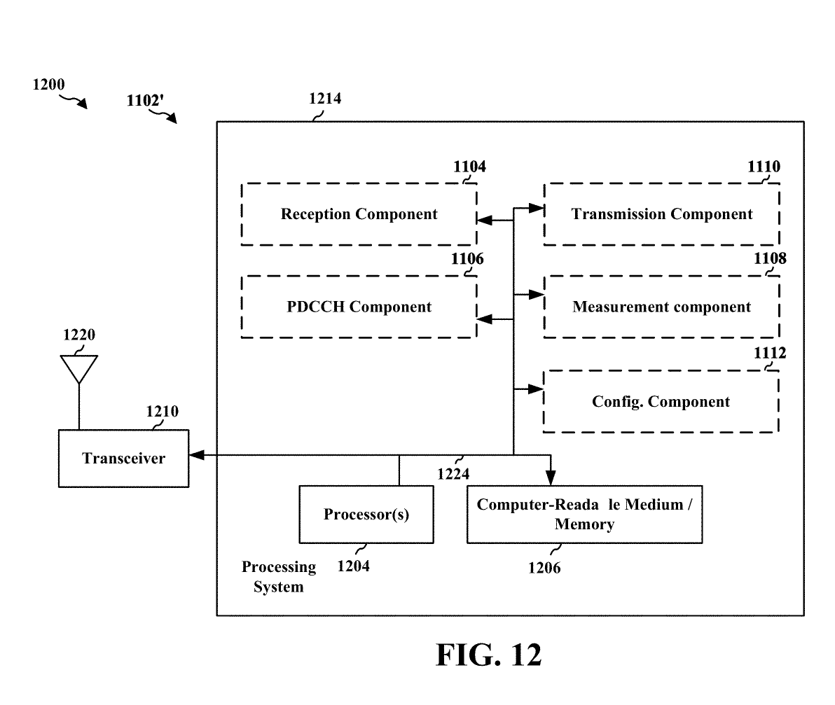

FIG. 12 is a diagram 1200 illustrating an example of a hardware implementation for an apparatus 1102′ employing a processing system 1214. The apparatus 1102′ may be a UE. The processing system 1214 may be implemented with a bus architecture, represented generally by a bus 1224. The bus 1224 may include any number of interconnecting buses and bridges depending on the specific application of the processing system 1214 and the overall design constraints. The bus 1224 links together various circuits including one or more processors and/or hardware components, represented by one or more processors 1204, the reception component 1104, the PDCCH component 1106, the measurement component 1108, the transmission component 1110, the configuration component 1112, and a computer-readable medium/memory 1206. The bus 1224 may also link various other circuits such as timing sources, peripherals, voltage regulators, and power management circuits, etc.

The processing system 1214 may be coupled to a transceiver 1210, which may be one or more of the transceivers 354. The transceiver 1210 is coupled to one or more antennas 1220, which may be the communication antennas 352.

The transceiver 1210 provides a means for communicating with various other apparatus over a transmission medium. The transceiver 1210 receives a signal from the one or more antennas 1220, extracts information from the received signal, and provides the extracted information to the processing system 1214, specifically the reception component 1104. In addition, the transceiver 1210 receives information from the processing system 1214, specifically the transmission component 1110, and based on the received information, generates a signal to be applied to the one or more antennas 1220.

The processing system 1214 includes one or more processors 1204 coupled to a computer-readable medium/memory 1206. The one or more processors 1204 are responsible for general processing, including the execution of software stored on the computer-readable medium/memory 1206. The software, when executed by the one or more processors 1204, causes the processing system 1214 to perform the various functions described supra for any particular apparatus. The computer-readable medium/memory 1206 may also be used for storing data that is manipulated by the one or more processors 1204 when executing software. The processing system 1214 further includes at least one of the reception component 1104, the PDCCH component 1106, the measurement component 1108, the transmission component 1110, and the configuration component 1112. The components may be software components running in the one or more processors 1204, resident/stored in the computer readable medium/memory 1206, one or more hardware components coupled to the one or more processors 1204, or some combination thereof. The processing system 1214 may be a component of the UE 350 and may include the memory 360 and/or at least one of the TX processor 368, the RX processor 356, and the communication processor 359.

In one configuration, the apparatus 1102/apparatus 1102′ for wireless communication includes means for performing each of the operations of FIGS. 9-10. The aforementioned means may be one or more of the aforementioned components of the apparatus 1102 and/or the processing system 1214 of the apparatus 1102′ configured to perform the functions recited by the aforementioned means.

As described supra, the processing system 1214 may include the TX Processor 368, the RX Processor 356, and the communication processor 359. As such, in one configuration, the aforementioned means may be the TX Processor 368, the RX Processor 356, and the communication processor 359 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
receiving resource elements in a time slot;
locating a first control resource set (CORESET) in the resource elements; and
performing, when the UE is configured to obtain a group common down link control channel, a first blind decoding on the first CORESET to obtain the group common down link control channel based on a group identifier.

2. The method of claim 1, further comprising:
locating a common search space in the first CORESET, wherein the blind decoding is performed on the common search space.

3. The method of claim 2, wherein the first CORESET is a common CORESET, wherein the first CORESET is determined based on information carried by a system information transmission.

4. The method of claim 3, wherein the system information transmission is a master information block (MIB).

5. The method of claim 2, wherein the first CORESET is an additional CORESET, wherein the first CORESET is determined based on information carried by a control message.

6. The method of claim 5, wherein the control message is a radio resource control (RRC) message.

7. The method of claim 2, further comprising:
determining an aggregation level of Control-Channel Elements (CCEs) carrying the group common down link control channel; and
determining, based on a configuration and the aggregation level, one or more sets of candidate CCEs in the common search space on which the first blind decoding is performed prior to the rest sets of candidate CCEs in the common search space, wherein the group common down link control channel is carried in one of the one or more sets of candidate CCEs.

8. The method of claim 1, further comprising: when the UE is not configured to obtain the group common down link control channel,
determining slot format information of one or more time slots based on a semi-static configuration when the semi-static configuration is received at the UE.

9. The method of claim 1, further comprising: when the UE is not configured to obtain the group common down link control channel and when a semi-static configuration is not received at the UE,
monitoring a UE specific down link control channel;
determining a first set of resource elements in the time slot assigned to reference signals based on information received through a control message; and
performing at least one of a radio resource management (RRM) measurement or a channel-state information (CSI) measurement at the first set of resource elements when each resource element of the first set of resource elements is in a down-link direction according to the UE specific down link control channel.

10. The method of claim 1, further comprising: when the UE fails to obtain the group common down link control channel through the first blind decoding,
determining a first set of resource elements assigned to reference signals based on information received through a control message; and
performing at least one of a radio resource management (RRM) measurement or a channel-state information (CSI) measurement at the first set of resource elements when each resource element of the first set of resource elements is in a down-link direction according to a semi-static configuration.

11. The method of claim 1, further comprising: when the UE obtains the group common down link control channel through the first blind decoding,
obtaining slot format information (SFI) of one or more time slots from the group common down link control channel;
obtaining a UE specific down link control channel carried in the one or more time slots;
determining a first direction of a first set of resource elements of in a particular time slot of the one or more time slots based on the SFI;
determining a second direction of the first resource element based on the UE specific down link control channel; and
determining that an error occurred in the particular time slot when the first direction is inconsistent with the second direction.

12. The method of claim 11, further comprising:
determining a third direction of the first set of resource elements according to a semi-static configuration; and
determining that an error occurred in the particular time slot when the first direction is inconsistent with the third direction.

13. The method of claim 11, further comprising:
determining that the first set of resource elements is assigned to a reference signal based on information received through a control message, wherein the first direction is determined to be an up-link direction; and
refraining from performing a measurement at the first set of resource elements.

14. The method of claim 2, wherein the group identifier is a group radio-network temporary identifier (RNTI), the method further comprising:
performing a second blind decoding on the common search space based on another RNTI, when the UE fails to obtain the group common down link control channel through the first blind decoding.

15. An apparatus for wireless communication, the apparatus being a user equipment (UE), comprising:
a memory; and
at least one processor coupled to the memory and configured to:
receive resource elements in a time slot;
locating a first control resource set (CORESET) in the resource elements; and
perform, when the UE is configured to obtain a group common down link control channel, a first blind decoding on the first CORESET to obtain the group common down link control channel based on a group identifier.

16. The apparatus of claim 15, wherein the at least one processor is further configured to:
locate a common search space in the first CORESET, wherein the blind decoding is performed on the common search space.

17. The apparatus of claim 16, wherein the first CORESET is a common CORESET, wherein the first CORESET is determined based on information carried by a system information transmission.

18. The apparatus of claim 17, wherein the system information transmission is a master information block (MIB).

19. The apparatus of claim 16, wherein the first CORESET is an additional CORESET, wherein the first CORESET is determined based on information carried by a control message.

20. A computer-readable medium storing computer executable code for wireless communication of a user equipment (UE), comprising code to:
receive resource elements in a time slot;
locating a first control resource set (CORESET) in the resource elements; and
perform, when the UE is configured to obtain a group common down link control channel, a first blind decoding on the first CORESET to obtain the group common down link control channel based on a group identifier.
